(19) United States
(12) Patent Application Publication
(10) Pub. No.: US 2021/0101040 A1
(43) Pub. Date: Apr. 8, 2021

(54) FIRE SUPPRESSANT FOAM FORMING COMPOSITIONS, PRECURSORS, THEIR USES AND METHODS OF MAKING THEM

(71) Applicant: IMERTECH SAS, Paris (FR)

(72) Inventors: Michael GREENHILL-HOOPER, Miradoux (FR); Adrien BORRAS, Toulouse (FR); Gilles COLLARD, Tournefeuille (FR)

(21) Appl. No.: 17/048,265

(22) PCT Filed: Apr. 17, 2019
(86) PCT No.: PCT/EP2019/060016

§ 371 Date: Oct. 16, 2020

(30) Foreign Application Priority Data
Apr. 17, 2018 (EP) 18305472.5

(51) Int. Cl. A62D 1/02; A62C 99/00

(52) U.S. Cl. CPC A62D 1/0071; A62C 99/0036

(57) ABSTRACT

The present invention relates to aqueous compositions for suppressing fires, comprising surfactants and/or hydrotropes, particulate inorganic materials selected from the group consisting of perlite, talc, calcium carbonate, kaolin, dolomite, mica, and bentonite, and combinations thereof, and optionally one or more additives. The invention further relates to uses of such particulate inorganic materials, as well as dry precursor compositions, fire suppressing compositions, and methods of making them.

### FIELD OF THE INVENTION

The present invention relates to both aqueous and dry compositions for forming foams suitable as fire extinguishing compositions and to fire extinguishing foams. The invention further relates to the use of particulate inorganic materials in the formation of foams, methods for improving foam stability, and methods of improving fire extinguishing properties of foams.

### BACKGROUND OF THE INVENTION

Aqueous foams are used to tackle so-called class B (liquid fuel) fires. The foams are particularly used in external environments when dealing with large scale fires and fire risks. Examples of use are for the suppression and prevention of aircraft and marine vessel fires, civil aviation facilities such as airports and at industrial installations where large volumes of potentially flammable liquids are used or stored, e.g. petrochemical refineries, oil and gas rigs and platforms. Other fire extinguishing media, applied in canisters are more commonly employed against smaller scale class B fire risks.

According to the state of the art, the preferred type of foam for this application, based on performance, are the so-called aqueous film forming foams (AFFF). The largest users of foam often specify only the use of this type of foam that rely on their unique ability to spread across the liquid fuel (oil). This property is linked to the very low aqueous surface tensions of their solutions. Once the foam provides a blanket coverage over the fuel, it must resist the tendency of the fuel to destabilise the foam and it must also prevent flammable vapour from the fuel from crossing the foam layer and coming into contact with the air above it and thus igniting. In the state of the art, this film-forming effect is imparted by fluorocarbon (FC) surfactants, such as for example shown in U.S. Pat. No. 4,424,133 A.

However, in recent years, FC surfactants have come under scrutiny as they tend to persist in the environment and can be toxic to aquatic life. C₈ chain-length FC surfactants are particularly harmful and have now either been banned by the relevant authorities or are subject to a self-imposed industry ban. By reducing the chain length from C₈ to C₆, they are less harmful, but there is still concern and it is likely that eventually the use of all FC surfactants in this application will be outlawed.

Recognising this, the fire-fighting foam producers are looking for alternative, non-FC surfactant based formulations. Some already exist, and are used, although none has the film-forming ability of the AFFFs. One improvement that is being sought and that can be realistically expected with newly developed formulations is a longer foam life, i.e., an improved foam stability. In the non-FC based formulations that are being developed, such as for example disclosed in WO 2012/123778 A1, attempts are being made to improve foam stability by the use of novel surfactants and polymers (gums). However, the problem is that such gums often act to increase viscosity and lead to problems with storage life time since the component mixtures tend to separate. High viscosity and separation of the components leads to problems when the compositions are diluted and/or foamed prior to use, while it is essential that the compositions are easy to use and reliable.

For example, US 2016/0023032 A1 discloses fire fighting compositions which comprise a combination of a high molecular weight water soluble anionic acrylic polymer, a polysaccharide gum and a surfactant, and which may achieve satisfactory fire extinguishing properties while at the same time having acceptable viscosity and storage stability. However, these fire fighting compositions are limited to very specific high molecular weight polymers in combination with specific gums.

WO 2017/161162 A1 discloses fluorine free fire extinguishing foams which comprise novel organosiloxane compounds which are intended to improve spreading and film formation of the foams. While the novel organosiloxane compounds may be easier to synthesise than previous organosilicon containing compounds, these compounds are not currently available on the market and separate production and distribution channels are required.

US 2017/0368395 A1 discloses fluorine free fire extinguishing foams which comprise a combination of two different surfactants employed at specific weight ratios. The foams disclosed therein achieve good spreading coefficients and fire extinguishing on small scale aviation fuel fires. However without the use of foam stabilisers, the foam stability is expected to be low.

The prior art therefore represents a number of different problems.

### SHORT DESCRIPTION OF THE INVENTION

The present invention is defined in the appended claims.

In particular, the present invention is embodied by an aqueous composition for suppressing fires, the composition comprising a surfactant and/or a hydrotrope, and a particulate inorganic material, selected from the group consisting of perlite, talc, calcium carbonate, kaoline, dolomite, mica, and bentonite, and combinations thereof. According to certain embodiments, the aqueous composition according to the present invention may further comprise one or more additives. According to the present invention, aqueous foam forming compositions are provided which do not require the use of fluorinated compounds and which have good fire-fighting properties, in particular for class B fires.

In a certain embodiment, the surfactant comprised in the aqueous composition of the present invention may be selected from the group of cationic surfactants, non-ionic surfactants and anionic surfactants. For example, the surfactant may be a cationic surfactant, such as for example an alkyl trimethyl ammonium halide such as tetradecyl trimethyl ammonium bromide or dicocodimethylammonium chloride, or dihydrogenated tallowoylethyl hydroxyethylammonium methosulfate, or a polymeric quaternary ammonium ester. According to a separate embodiment, the surfactant may be an anionic surfactant selected from alkyl ether sulphates, such as sodium lauryl ether sulphate, and alkyl sulphates, such as sodium lauryl sulphate. It was found that these types of surfactants were particularly useful in the present invention.

In a certain embodiment, the particulate inorganic material may be selected from the group consisting of talc, calcium carbonate, mica, and kaolin. In a further embodiment, the particulate inorganic material may be talc, such as for example microcrystalline talc, macrocrystalline talc, or a mixture thereof. It was found that these particulate inorganic materials offered particularly good performance. In a separate embodiment, the particulate inorganic material may be a synthetic talc.

According to a further embodiment, the microcrystalline talc may have a d₅₀ of 10 μm or lower, such as 5 μm or lower, such as ranging from 0.01 to 3.0 μm, such as about 0.01 μm, or about 1.0 μm, or about 2.0 μm. Depending on the intended use of the aqueous composition in accordance with the present invention, various particle size distributions may be selected.

In a certain embodiment, the ratio of surfactant to water is in the range of 0.01 to 5 wt.-%. It was found that within this range, best results were obtained regarding fire extinguishing properties, storage properties, as well as environmental sustainability.

In a certain embodiment, the ratio of particulate inorganic powder to surfactant is in the range of from 500:1 to 1:1. According to the present invention, the aqueous composition may be provided as a ready for use composition, or as a concentrate, which at the time of use in fire extinguishing application requires dilution using readily available local water sources, including salt water, sea water, and fresh water sources.

Also part of the present invention are dry precursor compositions comprising a surfactant and/or a hydrotrope, and a particulate inorganic material, selected from the group consisting of perlite, talc, calcium carbonate, dolomite, mica, and bentonite, and combinations thereof, and optionally one or more additives. It was found that such precursor compositions were, on the one hand, easy to handle and store, while on the other hand, after addition of water to obtain an aqueous composition in accordance with the present invention, they gave particularly stable and durable foams for use in fire extinguishing applications.

According to one embodiment, the dry precursor composition in accordance with this invention have a weight ratio of particulate inorganic powder to surfactant is in the range of from 500:1 to 1:1.

According to a separate embodiment, the invention concerns a fire extinguishing foam which comprises the aqueous composition in accordance with the present invention. For example, the aqueous composition according to the invention may be foamed using means known to the skilled person in the art in order to obtain the fire extinguishing foam according to the invention.

Also part of the present invention are methods of making a fire extinguishing foams using the dry precursor compositions and/or the aqueous compositions according to the present invention. According to a particular embodiment, the method comprises the steps of providing a mixture of water and surfactant and/or a hydrotrope, providing a particulate inorganic material, selected from the group consisting of perlite, talc, calcium carbonate, dolomite, mica, and bentonite, and combinations thereof, optionally providing one or more additives, mixing the provided mixture of water and surfactant and/or a hydrotrope, the provided particulate inorganic material and optionally the provided said one or more additives, and finally foaming the obtained mixture. It was found that good foam stability could be obtained using the method of formation in accordance with the present invention.

According to a separate embodiment, the method comprises the steps of providing a dry precursor of the present invention, providing water, optionally providing one or more additives, mixing the provided dry precursor, the provided water and optionally the provided one or more additives, and finally foaming the obtained mixture. It was found that good foam stability could be obtained using the method of formation in accordance with the present invention.

Also part of the present invention is the use of a particulate inorganic materials in an aqueous composition according to the invention, and by extension in a fire extinguishing foam according to the present invention. According to this invention, the particulate inorganic materials for the said use is selected from the group consisting of perlite, talc, calcium carbonate, dolomite, mica, and bentonite, and combinations thereof.

Also part of the present invention is a method of extinguishing a fire comprising the use of a particulate inorganic mineral in accordance with the present invention, or an aqueous composition in accordance with the present invention.

### SHORT DESCRIPTION OF THE FIGURES

The invention will be further illustrated by reference to the following FIGURE:

FIG. 1 graphically represents Examples 10 to 39 of the experimental section disclosed herein (see below), as well as the geographical origin of the various talc samples tested.

It is understood that the following description and references to the FIGURES concern exemplary embodiments of the present invention and shall not be limiting the scope of the claims.

### DETAILED DESCRIPTION OF THE INVENTION

The present invention according to the appended claims provides an aqueous composition for the formation of a foam, in particular a foam for use in fire extinguishing applications, in particular for class B fires. Aqueous foams are already employed to extinguish class B fires. The foams in accordance with the present invention avoid the need to use FC based formulations and are environmentally friendly, while at the same time use readily available components and improve fire extinguishing properties by increasing foam stability.

According to the present invention, it was found that more stable foams can be formed by the addition of particulate inorganic materials to the aqueous foam forming compositions. In particular, it was found that the foams formed according to the present invention do not collapse as easily as state of the art foams, and maintain their foamy structure over a longer period of time. While in laboratory tests, state of the art foams were found to lose about 80% or more of their initial mass by water drainage within 10 minutes of formation, foams formed according to the present invention were found to maintain up to 90% of their initial mass after 60 minutes. These values were obtained by using the method as described in the Examples section of the present description.

Without intending to be bound by theory, it is thought that the particulate inorganic materials remain at the water-air interface of the foam bubbles to improve the foam stability. The ratio of surfactant to particulate inorganic material therefore needs to be balanced. When there is too much surfactant, it absorbs excessively onto the inorganic particulate material and causes it to move into the water phase, away from the interface. In one particular embodiment, the surfactant is above the critical micelle concentration for good foam formation.

According to the present invention, the surfactants absorb onto the inorganic particulate materials in the aqueous composition. Such surfactants are also known as collectors. For example, a cationic surfactant may adhere to a negatively charged surface of an inorganic particle, such as talc.

According to the present invention, an aqueous composition for forming a fire extinguishing foam is provided, the composition comprising a surfactant and/or a hydrotrope, a particulate inorganic material selected from the group consisting of perlite, talc, calcium carbonate, dolomite, mica, and bentonite, and combinations thereof, and optionally one or more additives.

### Surfactants or Hydrotropes

Surfactants, or foaming agents, for example for use in foams for fire extinguishing applications are known in the art. In certain embodiments, the surfactant comprises or is one or more anionic surfactants, or one or more cationic surfactants, or one or more non-ionic surfactants, or combinations thereof.

Suitable anionic surfactants include, but are not limited to, alkyl ether sulphates, such as sodium lauryl ether sulphate, and alkyl sulphates, such as sodium lauryl sulphate. Suitable anionic surfactants further include ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium laureth sulfate, sodium lauryl sarcosinate, sodium lauroyl sarcosinate, potassium lauryl sulfate, sodium trideceth sulfate, sodium methyl lauroyl taurate, sodium lauroyl isethionate, sodium laureth sulfosuccinate, sodium lauroyl sulfosuccinate, sodium tridecyl benzene sulfonate, sodium dodecyl benzene sulfonate, sodium lauryl amphoacetate, sodium lauryl sulfoacetate, sodium cocoyl isethionate, sodium methyl cocoyl taurate, phosphate ester based surfactants such as alkyl-aryl ether phosphates and alkyl ether phosphates, and mixtures thereof. The anionic surfactant may be, for example, an aliphatic sulfonate, such as a primary C₈-C₂₂ alkane sulfonate, primary C₈-C₂₂ alkane disulfonate, C₈-C₂₂ alkene sulfonate, C₈-C₂₂ hydroxyalkane sulfonate or alkyl glyceryl ether sulfonate.

Suitable cationic surfactants include, but are not limited to, alkyl trimethyl ammonium halides, or dialkyl dimethyl ammonium halides, wherein the alkyl group may comprise from 8 to 24 carbon atoms, such as for example 10 or 12 or 14 or 16 or 18 or 20 or 22 carbon atoms, such as tetradecyltrimethylammonium bromide, or dicocodimethylammonium chloride. Other suitable cationic surfactants are quaternary ammonium species such as dihydrogenated tallowoylethyl hydroxyethylammonium methosulfate, or a polymeric quaternary ammonium esters as described in U.S. Pat. No. 8,936,159 B2, the contents of which are incorporated herein by reference. Without wanting to be bound by theory, it is thought that a cationic surfactant is likely to be acting more like a collector does in flotation systems. Thus, given the negative charge on the particle surfaces in near neutral pH conditions, a cationic surfactant is likely to more strongly adsorb onto the particles than the an anionic surfactant, which may still absorb on talc, but more likely via adsorption of its hydrophobic tail.

Suitable non-ionic surfactants include alcohols, acids, amides or alkyl phenols reacted with alkylene oxides, especially ethylene oxide either alone or with propylene oxide. Exemplary non-ionics are C₆-C₂₂ alkyl phenols-ethylene oxide condensates, the condensation products of C₈-C₁₈ aliphatic primary or secondary linear or branched alcohols with ethylene oxide, and products made by condensation of ethylene oxide with the reaction products of propylene oxide and ethylenediamine. Other non-ionics include long chain tertiary amine oxides. Other non-ionics are surfactants based on cocoamide and produced by reacting cocoamide with an alcohol amine, such as ethanolamine. Exemplary non-ionics include cocoamide MEA and cocoamide DEA. Other suitable non-ionics include alkyl polyglucosides such as decyl glucoside, lauryl glucoside and octyl glucoside.

In certain embodiments, the surfactant is a sodium lauryl sulphate (or sodium dodecyl sulfate, SDS), or a sodium lauryl ether sulphate (SLES). In certain embodiments, the surfactant is tetradecyltrimethylammonium bromide (TTAB), or dicocodimethylammonium chloride.

The surfactant should be present in the aqueous composition according to one aspect of the present invention in an amount below or above the critical micelle concentration (CMC). CMC is defined as the concentration of surfactants above which micelles form and all additional surfactants added to the system go to micelles. If there is too much surfactant present in the composition, it may move the particulate inorganic material into the aqueous phase, preventing it from exercising its foam stabilising properties. The ratio of surfactant to inorganic particulate material therefore needs to be balanced. State of the art compositions may require a ratio of surfactant to water of up to 5.0 wt.-%.

In certain embodiments, the ratio of surfactant to water in the composition according to the invention is in the range of 0.01 to 5 wt.-%. For example, the ratio of surfactant to water in the composition may be in the range of 0.05 to 4 wt.-%, such as for example 0.1 to 3 wt.-%, such as for example about 0.05 wt.-%, about 0.3 wt.-%, about 0.5 wt.-%, about 1 wt.-%, about 2 wt.-%, about 3 wt.-%, about 4 wt.-%, or about 5 wt.-%. For example, according to the present invention, a ready to be foamed composition may have a ratio of surfactant to water from about 0.05 wt.-% to about 0.1 wt.-%. A concentrate which requires dilution prior to foaming may have a ratio of surfactant to water from about 0.5 wt.-% to about 5 wt.-% or to about 1 wt.-%.

### Particulate Inorganic Material

According to the present invention, the stability of the foams formed from the inventive aqueous composition is improved by the presence of a particulate inorganic material.

Unless otherwise stated, particle size properties referred to herein for the inorganic particulate materials are as measured in a well-known manner by sedimentation of the particulate material in a fully dispersed condition in an aqueous medium using a Sedigraph 5100 machine as supplied by Micromeritics Instruments Corporation, Norcross, Ga., USA (web-site: www.micromeritics.com), referred to herein as a “Micromeritics Sedigraph 5100 unit”. Such a machine provides measurements and a plot of the cumulative percentage by weight of particles having a size, referred to in the art as the ‘equivalent spherical diameter’ (e.s.d), less than given e.s.d values. The mean particle size d₅₀ is the value determined in this way of the particle e.s.d at which there are 50% by weight of the particles which have an equivalent spherical diameter less than that d₅₀ value. The top cut particle size d₉₀ is the value determined in this way of the particle e.s.d at which there are 90% by weight of the particles which have an equivalent spherical diameter less than that d₉₀ value.

The particulate inorganic material shall have a particle size range that renders it suitable for foam formation, although the particle size range shall not be specifically limited. For example, the inorganic particulate material may have a mean particle size d₅₀ from about 0.01 μm to about 1 mm, provided that stable foams may be formed with such particulate material. For example, the particulate inorganic material may have a d₅₀ no greater than about 500 μm, for example no greater than about 250 μm, or no greater than about 100 μm, or no greater than about 50 μm. In certain embodiments, the inorganic particulate material has a d₅₀ of no greater than about 25 μm, for example, no greater than about 10 μm, or no greater than about 5 μm, or no greater than about 1 μm. In certain embodiments, the inorganic particulate material has a d₅₀ of from about 0.05 μm to about 5 μm, for example, or from about 0.1 μm to about 2.5 μm, or from about 0.5 μm to about 1 μm.

In certain embodiments, the particulate inorganic material may have a d₉₀ no greater than about 1 mm, for example no greater than about 500 μm, or no greater than about 400 μm, or no greater than about 300 μm, or no greater than about 200 μm, or no greater than about 100 μm. In certain embodiments, the inorganic particulate material has a d₉₀ of no greater than about 50 μm, for example, no greater than about 20 μm, or no greater than about 10 μm, or no greater than about 5 μm. In certain embodiments, the inorganic particulate material has a d₉₀ of from about 0.5 μm to about 10 μm, for example, or from about 1 μm to about 7.5 μm, or from about 2.5 μm to about 5 μm.

In certain embodiments, the inorganic particulate material is selected from the group consisting of perlite, talc, calcium carbonate, kaolin, dolomite, mica, and bentonite, and combinations thereof.

In certain embodiments, the inorganic particulate material is selected from the group consisting of talc, calcium carbonate, mica, kaolin, and combinations thereof.

In certain embodiments, the inorganic particulate material is talc, such as a macrocrystalline talc, or a microcrystalline talc, or a combination thereof. The individual platelet size, i.e. the median diameter as measured by the Sedigraph method, of an individual talc platelet (a few thousand elementary sheets) can vary from approximately 1 μm to over 100 μm, depending on the conditions of formation of the deposit. The individual platelet size determines the lamellarity of the talc. A highly lamellar talc will have large individual platelets, whereas a microcrystalline talc will have small platelets. Although all talcs may be termed lamellar, their platelet size differs from one deposit to another. Small crystals provide a compact, dense ore, known as microcrystalline talc. Large crystals come in papery layers, known as macrocrystalline talc. Known microcrystalline talc deposits are located in Montana (Yellowstone) and in Australia (Three Springs). In a microcrystalline structure, talc elementary particles are composed of small plates compared to macrocrystalline structures, which are composed of larger plates.

According to certain embodiments, the inorganic particulate material is a microcrystalline talc having a d₉₀ of about 50 μm or less, such as for example 30 μm or less, such as for example 20 μm or less, such as for example 10 μm or less, such as for example about 5 μm, and a d₅₀ of about 20 μm or less, such as for example 10 μm or less, such as for example 5 μm or less, such as for example 3 μm or less, such as for example about 3 μm or about 1 μm.

According to certain embodiments, the inorganic particulate material is bentonite, for example a bentonite having a d₉₅ of about 100 μm or less, such as for example 80 μm or less, such as for example 70 μm or less, such as for example 65 μm or less, such as for example about 62 μm, and a d₅₀ of about 30 μm or less, such as for example 20 μm or less, such as for example 19 μm or less, such as for example 18 μm or less, such as for example about 17 μm (all measured by wet Malvern laser scattering—ISO 13329-1).

As discussed above, the amounts of surfactant and inorganic particulate material need to be balanced, in order to avoid that the inorganic particulate material is moved into the aqueous phase by the surfactant, away from the water-air interface of the foam bubbles, preventing it from developing its foam stabilising properties.

According to certain embodiments, the ratio of particulate inorganic powder to water in the aqueous composition according to the present invention may be in the range of 0.1 to 60 wt.-%, such as for example in the range from 0.5 wt.-% to 60 wt.-%, such as for example in the range from 1 wt.-% to 60 wt.-%, such as for example in the range from 2 wt-% to 50 wt.-%, or in the range from 3 wt.-% to 20 wt.-%, or in the range of 4 to 10 wt.-%, such as for example about 4 wt.-%, or about 5 wt.-%, or about 6 wt.-%, or about 8 wt.-%, or about 10 wt.-%, or about 12 wt.-%. For example, according to the present invention, a ready to be foamed composition may have a ratio of particulate inorganic powder to water from about 1 wt.-% to about 6 wt.-% or to about 3 wt.-%. A concentrate which requires dilution prior to foaming may have a ratio of surfactant to water from about 10 wt.-% to about 60 wt.-% or to about 30 wt.-%.

According to certain embodiments, the ratio of particulate inorganic powder to surfactant in the aqueous composition according to the present invention may be in the range of 500:1 to 1:1, such as for example in the range of 300:1 to 2:1, or 250:1 to 5:1, or 200:1 to 10:1, or 100:1 to 50:1, such as for example about 200:1, or about 100:1, or about 50:1.

### Further Components and Additives

Viscosity increasing polymers are known to the skilled person in the art and may include gums, such as xanthan gums. These may also act as film formers and foam stabilisers.

Minerals based anti-settling agents are known to the skilled person in the art. For example, attapulgite (“Attagel 40”, BASF), kaolin and/or sepiolite may be employed.

Glycol ethers may be employed as anti-freeze agents, foam boosters and solvents.

Further additives that may be included in the compositions in accordance with the present invention include corrosion inhibitors, anti-microbial additives, hardness ion sequestrants, pH buffers, and/or salts to control foaming with soft water, in order to allow the use of the compositions according to the present invention with fresh water, or sea water, as may be required.

According to one embodiment, the aqueous composition in accordance with the present invention comprises very little fluorinated compounds, such as for example less than 1 wt.-% fluorinated compounds, or less than 1.0 wt.-% fluorinated compounds, or less than 0.5 wt.-% fluorinated compounds, or less than 0.1 wt.-% fluorinated compounds, or less than 0.05 wt.-% fluorinated compounds, or less than 0.01 wt.-% fluorinated compounds, or less than 0.001 wt.-% fluorinated compounds, or no detectable fluorinated compounds.

### Dry Precursor Compositions

Also part of the present invention are dry precursor compositions for making the aqueous compositions in accordance with the present invention. According to one embodiment, the dry precursor composition consists of a particulate inorganic material, selected from the group consisting of perlite, talc, calcium carbonate, dolomite, and bentonite, and combinations thereof, and a surfactant and/or hydrotrope. The said particulate inorganic material and the said surfactant and/or hydrotrope are combined in such amounts that by mere addition of water, an aqueous composition in accordance with the present invention may be obtained.

For example, the surfactant may comprise or consist of one or more anionic surfactants, or one or more cationic surfactants, or one or more non-ionic surfactants, or combinations thereof, as discussed above in the case of the aqueous compositions in accordance with the present invention. Furthermore, for example, the particulate inorganic material may be selected from the materials, particle size distributions, and quality as discussed above in the case of the aqueous compositions in accordance with the present invention.

In accordance with one embodiment of the present invention, the dry precursor composition further comprises one or more additives.

### Method of Formation of the Aqueous Compositions

According to one embodiment of the present invention, the aqueous compositions may be obtained by providing a dry precursor composition according to the invention, and by adding the required amount of water to obtain an aqueous composition in accordance with the invention. According to a further embodiment of the present invention, the aqueous compositions may be obtained by mixing water and surfactant and/or hydrotrope in the required amounts, and by adding the particulate mineral material under stirring to obtain an aqueous composition in accordance with the invention. In accordance with this embodiment, the said particulate mineral material may be added in a dry state, or in a wet (aqueous) state, or as a suspension, such as for example an aqueous suspension.

The aqueous compositions according to the present invention may be foamed in order to form a fire extinguishing foam, which also forms part of the present invention.

### Use of the Aqueous Compositions

As discussed, above, the aqueous compositions may be used for forming fire extinguishing foams. As such the compositions may be present in various concentrations, depending on whether they are intended to be foamed as they are, or whether they may be diluted from using readily available water source. For example, in the case of compositions for use to extinguish fires at sea, such as for fires on oil and gas rigs and platforms, or on marine vessels, concentrated compositions that may be diluted with sea water prior to foaming may be stored. On the other hand, in places where water for dilution is not readily available, or where the compositions need to be foamed quickly, such as for examples within industrial installations, or at airports, the compositions may be maintained at a lower concentration or a ready-to-use aqueous dilution. Therefore the aqueous compositions in accordance with the present invention may be provided as concentrates with low water content, or as dilute aqueous compositions with high water content. Accordingly, the content of particulate inorganic powder in the aqueous compositions may be the range of 0.1 wt.-% to 60 wt.-%, based on the total weight of the composition.

The aqueous compositions may be foamed using the methods known to the skilled person in the art, i.e. foaming by mechanical means. Such mechanical means may include foam nozzles or foam generators. The use of inorganic particulate materials as discussed herein for the formation of fire extinguishing foams is part of the present invention. In accordance with the present invention, the use of inorganic particulate materials leads to more stable foams which in use remain longer on the surface of a burning fuel in a class B fire, with a low decomposition rate, and low rate of mixing into the burning fuel.

In addition, even after decomposition or evaporation of the foam, the inorganic particulate materials present in the fire extinguishing composition remain in the system, because they are generally stable at the temperatures encountered in a class B fire, with no decomposition expected below 1000° C. Accordingly, the inorganic particulate materials may provide an insulating blanket that will also retain its foam structure even if the water in the foam has evaporated.

Finally, the inorganic particulate materials for use according to the present invention are readily available on the world market, and do not carry the risk of environmental pollution after use in a fire fighting foam. The foams according to the present invention do not contain any fluorinated components and have a lower surfactant content than the foams of the state of the art.

### Foam Expansion Ratio (FER)

It was further found that the compositions according to the present invention had satisfactory to excellent foaming properties. Foam expansion ratios (FER) of close to 5 or more could be obtained with standard tap water, and even from 8 to over 20. As used herein, the FER was calculated by dividing the volume of the expanded foam by the volume of the solution prior to foaming: FER=V_{foam}/Vₛₒₗᵤₜᵢₒₙ.

It should be noted that the present invention may comprise any combination of the features and/or limitations referred to herein, except for combinations of such features which are mutually exclusive. The foregoing description is directed to particular embodiments of the present invention for the purpose of illustrating it. It will be apparent, however, to one skilled in the art, that many modifications and variations to the embodiments described herein are possible. All such modifications and variations are intended to be within the scope of the present invention, as defined in the appended claims.

### EXAMPLES

### Examples 1 to 5

Various inorganic particulate materials were tested for their foam stabilisation properties.

A number of inorganic particulate materials (10 wt.-%) were mixed into a 0.3 wt.-% foamed solution of sodium lauryl ether sulphate (MEYCO SLF 30, provided by BASF) in water, and the resulting compositions mixed using a laboratory foam generator. The resulting foams (60 g) were filled into a funnel cell with a frit sufficiently coarse such that the mineral particles do not block water drainage from the foam thereby affecting the results, and a collector at the bottom, and left to stand. Any foam decomposition was measured by measuring the amount of water collected underneath the funnel cell.

The particulate inorganic materials tested are shown in Table I:

TABLE I

| Example | Mineral |
|---|---|
| 1 | CaCO₃ |
| 2 | Dolomite |
| 3 | Kaolin |
| 4 and 5 | Talc |
| Comp. Ex. 1 | none |

The amount of water collected was observed for 30 minutes. The results are shown in Table II. The values shown are percentage values of foam remaining within the funnel cell, and can be seen as a measure of foam stability over time.

TABLE II

| | Time (min) | | | | | | | | | |
|---|---|---|---|---|---|---|---|---|---|---|
| | 0 | 1 | 2 | 3 | 4 | 5 | 7.5 | 10 | 15 | 30 |
| Comp. | 100 | 85 | 63 | 47 | 38 | 34 | 26 | 22 | 16 | 11 |
| Ex. 1 | | | | | | | | | | |
| Ex. 1 | 100 | 100 | 98 | 96 | 93 | 89 | 80 | 72 | 60 | 45 |
| Ex. 2 | 100 | 99 | 96 | 91 | 85 | 80 | 66 | 56 | 43 | 18 |
| Ex. 3 | 100 | 96 | 86 | 75 | 65 | 59 | 46 | 38 | 27 | 13 |
| Ex. 4 | 100 | 100 | 100 | 100 | 100 | 100 | 100 | 100 | 99 | 95 |
| Ex. 5 | 100 | 100 | 100 | 99 | 98 | 96 | 92 | 87 | 79 | 67 |

It was found that all inorganic particulate materials lead to improved foam stability. For Example 4 (talc), the stability after 60 minutes was 91%. The talc used in Example 4 is a microcrystalline talc having a d₉₀ of 5 μm and a d₅₀ of 1 μm. The talc used in Example 5 is a macrocrystalline talc having a d₉₅ of 6.2 μm and a d₅₀ of 1.8 μm (by Sedigraph—ISO 13317-3).

### Examples 6 and 7

In a further test series, a 3 wt.-% foamed solution of sodium lauryl ether sulphate (MEYCO SLF 30, provided by BASF) in water and without inorganic particulate matter was compared to other surfactants with and without inorganic particulate matter. Polymer A is sodium lauryl sulphate (SLS) and Polymer B is tetradecyltrimethylammonium bromide (TTAB). The compositions as shown in Table III were mixed using a laboratory foam generator. The talc used in Examples 6 and 7 is a macrocrystalline talc having a d₉₅ of 6.2 μm and a d₅₀ of 1.8 μm (by Sedigraph—ISO 13317-3).

TABLE III

| Example | Composition |
|---|---|
| Comp. Ex. 2 | Water, 3 wt.-% MEYCO SLF 30 |
| Comp. Ex. 3 | Water, 3 wt.-% SLS |
| Ex. 6 | Water, 5 wt.-% talc, 0.05 wt.-% SLS |
| Ex. 7 | Water, 5 wt.-% talc, 0.05 wt.-% TTAB |

The resulting foams (60 g) were filled into a funnel cell with a frit and collector at the bottom, and left to stand. Again, any foam decomposition was measured by measuring the amount of water collected underneath the funnel cell. The results are shown in Table IV.

TABLE IV

| | Time (min) | | | | | | |
|---|---|---|---|---|---|---|---|
| | 0 | 5 | 10 | 15 | 20 | 25 | 30 |
| Comp. | 100 | 69 | 53 | 36 | 29 | 23 | 19 |
| Ex. 2 | | | | | | | |
| Comp. | 100 | 69 | 48 | 37 | 29 | 23 | 19 |
| Ex. 3 | | | | | | | |
| Ex. 6 | 100 | 84 | 77 | 76 | 75 | 74 | 74 |
| Ex. 7 | 100 | 100 | 99.5 | 97.2 | 95.4 | 93.5 | 92.6 |

It is shown that the addition of 5 wt.-% talc with concurrent strong reduction of surfactant from 3 wt.-% to 0.05 wt.-% leads to reduced foam decomposition for SLS. In addition it was shown that the performance of TTAB is better than that of SLS.

### Examples 8 and 9

Foams were tested in the presence of various amounts of talc and tetradecyltrimethylammonium bromide (TTAB), using either demineralised water (Example 8) or standard tap water (Example 9). The talc used was a microcrystalline talc provided by Imerys Talc having a BET surface area of 21 m²/g (ISO 9277) and a median particle size of 1.1 μm (by Sedigraph—ISO 13317-3). TTAB was used as a 5% aqueous stock solution. The foams were prepared by combining talc and TTAB stock solution and making up to 100 g using demineralised or tap water. The resulting compositions mixed using a laboratory foam generator. The resulting foams were filled into a funnel cell with a frit and collector at the bottom, and left to stand. Any foam decomposition was measured by measuring the amount of water collected underneath the funnel cell. The varying test parameters are shown in Table V.

TABLE V

| Example | Parameters |
|---|---|
| Ex. 8a | 0.05 wt.-% TTAB, 2.5 wt.-% talc |
| Ex. 8b | 0.05 wt.-% TTAB, 5 wt.-% talc |
| Ex. 8c | 0.10 wt.-% TTAB, 2.5 wt.-% talc |
| Ex. 8d | 0.10 wt.-% TTAB, 5 wt.-% talc |
| Ex. 8e | 0.15 wt.-% TTAB, 2.5 wt.-% talc |
| Ex. 8f | 0.15 wt.-% TTAB, 5 wt.-% talc |
| Ex. 9a | 0.05 wt.-% TTAB, 2.5 wt.-% talc |
| Ex. 9b | 0.05 wt.-% TTAB, 5 wt.-% talc |
| Ex. 9c | 0.10 wt.-% TTAB, 2.5 wt.-% talc |
| Ex. 9d | 0.10 wt.-% TTAB, 5 wt.-% talc |
| Ex. 9e | 0.15 wt.-% TTAB, 2.5 wt.-% talc |
| Ex. 9f | 0.15 wt.-% TTAB, 5 wt.-% talc |

The amount of water collected was observed for 30 minutes. The results are shown in Table VI. The values shown are percentage values of foam remaining within the funnel cell, and can be seen as a measure of foam stability over time. The values shown in the column “FER” indicate the obtained foam expansion ratios.

TABLE VI

| | Time (min) | | | | | | | |
|---|---|---|---|---|---|---|---|---|
| | 0 | 5 | 10 | 15 | 20 | 25 | 30 | FER |
| Ex. 8a | 100 | 79 | 72 | 67 | 66 | 65 | 64 | 6.6 |
| Ex. 8b | 100 | 82 | 76 | 73 | 70 | 69 | 68 | 3.7 |
| Ex. 8c | 100 | 90 | 78 | 69 | 63 | 59 | 56 | 18.9 |
| Ex. 8d | 100 | 91 | 83 | 78 | 76 | 73 | 71 | 7.6 |
| Ex. 8e | 100 | 88 | 69 | 55 | 44 | 36 | 31 | 22.8 |
| Ex. 8f | 100 | 100 | 96 | 87 | 81 | 75 | 70 | 15.3 |
| Ex. 9a | 100 | 70 | 62 | 58 | 56 | 54 | 53 | 10.6 |
| Ex. 9b | 100 | 77 | 71 | 67 | 66 | 64 | 63 | 5.4 |
| Ex. 9c | 100 | 89 | 74 | 63 | 55 | 49 | 46 | 27.5 |
| Ex. 9d | 100 | 91 | 82 | 76 | 73 | 70 | 68 | 12.5 |
| Ex. 9e | 100 | 94 | 77 | 58 | 48 | 41 | 38 | 38.8 |
| Ex. 9f | 100 | 99 | 95 | 86 | 80 | 75 | 71 | 22.0 |

It was found that all the Examples lead to improved foam stability over Comp. Ex. 1 (see Table II above).

### Examples 10 to 17

Foams were tested in the presence of various amounts of talc and surfactants, using standard tap water. The talc used in Examples 10 to 12 was a microcrystalline talc provided by Imerys Talc having a BET surface area of 21 m²/g (ISO 9277) and a median particle size of 1.1 μm (by Sedigraph—ISO 13317-3). The talc used in Examples 13 to 15 was a microcrystalline talc having a median particle size of 0.5 μm (by Sedigraph—ISO 13317-3). The talc used in Examples 16 and 17 was a synthetic talc as explained below. The foams were prepared by diluting 3 wt.-% stock solutions of various surfactants in water to obtain dilute solutions of surfactant in water, followed by addition of the talc and making up to 100 g using tap water. The resulting compositions were mixed using a laboratory foam generator. The resulting foams were filled into a funnel cell with a coarse frit and collector at the bottom, and left to stand. Any foam decomposition was measured by measuring the amount of water collected underneath the funnel cell. The varying test parameters are shown in Table VII.

The said synthetic talc was obtained in accordance with the methods including solvothermal treatment at a pressure greater than 1 MPa and at temperatures from 100° C. to 600° C., as disclosed in WO 2015/159006 (continuous process) or WO 2008/009799 (batch process). The synthetic talc thus obtained was characterised by X-ray diffraction analysis, wherein the diffraction pattern showed a peak located at a distance of the order of 9.40 to 9.68 Å, for a plane (001), a peak located at 4.50 to 4.75 Å, for a plane (020), a peak located at 3.10 to 3.20 Å, for a plane (003), and a peak located at 1.50 to 1.55 Å, for a plane (060). The synthetic talc has a d₅₀ median particle size of 500 nm and a BET surface area in the range of 300 to 500 m²/g.

TABLE VII

| Example | Parameters |
|---|---|
| Ex. 10 | 0.05 wt.-% SLS, 5 wt.-% talc |
| Ex. 11 | 0.05 wt.-% SLES, 5 wt.-% talc |
| Ex. 12 | 0.05 wt.-% Arquad C-35, 5 wt.-% talc |
| Ex. 13 | 0.05 wt.-% SLS, 5 wt.-% talc |
| Ex. 14 | 0.05 wt.-% SLES, 5 wt.-% talc |
| Ex. 15 | 0.05 wt.-% Arquad C-35, 5 wt-% talc |
| Ex. 16 | 0.05 wt.-% SLS, 5 wt.-% synthetic talc |
| Ex. 17 | 0.05 wt.-% SLS, 5 wt.-% synthetic talc |

Sodium lauryl sulphate (SLS) and sodium lauryl ether sulphate (SLES) were compared to Arquad C-35. ARQUAD C35 is a 35% by weight solution of cocotrimethylammonium chloride in water. The amount of water collected was observed for 30 minutes. The results are shown in Table VIII. The values shown are percentage values of foam remaining within the funnel cell, and can be seen as a measure of foam stability over time. The values shown in the column “FER” indicate the obtained foam expansion ratios.

TABLE VIII

Time (min)

| | 0 | 5 | 10 | 15 | 30 | FER |
|---|---|---|---|---|---|---|
| Ex. 10 | 100 | 96 | 88 | 83 | 76 | 16.5 |
| Ex. 11 | 100 | 99 | 96 | 93 | 89 | 6.5 |
| Ex. 12 | 100 | 93 | 88 | 85 | 80 | 6.3 |
| Ex. 13 | 100 | 99 | 96 | 91 | 83 | 8.1 |
| Ex. 14 | 100 | 92 | 87 | 82 | 75 | 4.1 |
| Ex. 15 | 100 | 99 | 96 | 94 | 89 | 7.9 |
| Ex. 16 | 100 | 100 | 100 | 99.8 | 99.6 | 10.5 |
| Ex. 17 | 100 | 100 | 100 | 100 | 99.9 | 10.2 |

It was found that all the Examples lead to improved foam stability over Comp. Ex. 1 (see Table II above).

### Examples 18 to 23

Foams were tested in the presence of various amounts of talc which had been wetted with a 15 wt.-% surfactant in water solution, using standard tap water. The talc used in Examples 18 to 23 was a microcrystalline talc provided by Imerys Talc having a BET surface area of 21 m²/g (ISO 9277) and a median particle size of 1.1 μm (by Sedigraph—ISO 13317-3), which had been made up as a wet talc composition comprising talc and 15 wt.-% surfactant-in-water. Water was added gradually while mixing to obtain the aqueous solution which was subsequently foamed. Foam stability was tested in the same way as for Examples 10 to 17 (see above). The compositions employed and the results are shown in Tables IX and X.

TABLE IX

| Example | Parameters |
|---|---|
| Ex. 18 | 0.025 wt.-% SLS, 5 wt.-% talc |
| Ex. 19 | 0.05 wt.-% SLS, 5 wt.-% talc |
| Ex. 20 | 0.10 wt.-% SLS, 5 wt.-% talc |
| Ex. 21 | 0.025 wt.-% SLS, 5 wt.-% talc |
| Ex. 22 | 0.05 wt.-% SLS, 5 wt.-% talc |
| Ex. 23 | 0.10 wt.-% SLS, 5 wt.-% talc |

In Examples 18 to 20, the compositions were foamed immediately after formation. In Examples 21 to 23, the compositions were foamed 7 days after formation.

TABLE X

Time (min)

| | 0 | 5 | 10 | 15 | 30 | FER |
|---|---|---|---|---|---|---|
| Ex. 18 | 100 | 100 | 90 | 82 | 69 | 17.4 |
| Ex. 19 | 100 | 100 | 99 | 95 | 87 | 15.7 |
| Ex. 20 | 100 | 95 | 90 | 87 | 83 | 6.5 |
| Ex. 21 | 100 | 100 | 90 | 80 | 65 | 20.6 |
| Ex. 22 | 100 | 100 | 98 | 95 | 86 | 15.7 |
| Ex. 23 | 100 | 95 | 91 | 87 | 83 | 8.0 |

### Examples 24 and 25

Foams were tested in the presence of various amounts of talc which had not been wetted prior to use and prior to being mixed with surfactants, using standard tap water. The talc used in Examples 24 to 25 was a microcrystalline talc provided by Imerys Talc having a BET surface area of 21 m²/g (ISO 9277) and a median particle size of 1.1 μm (by Sedigraph—ISO 13317-3), which had been mixed with SLS in a 100:1 weight ratio (5 g talc and 0.05 g SLS), prior to addition of water. Water was added to obtain 100 g of aqueous composition, which was subsequently foamed, giving aqueous foams comprising 0.05 wt.-% SLS and 5 wt.-% talc. Foam stability was tested in the same way as for Examples 10 to 17 (see above). In Example 24, the composition were foamed immediately after formation. In Example 25, the composition was foamed 14 days after formation. The results are shown in Table Xl.

TABLE XI

Time (min)

| | 0 | 5 | 10 | 15 | 30 | FER |
|---|---|---|---|---|---|---|
| Ex. 24 | 100 | 100 | 100 | 100 | 95 | 8.3 |
| Ex. 25 | 100 | 100 | 100 | 99 | 90 | 11.2 |

### Examples 26 to 55

Foams were tested in the presence of equal amounts of various microcrystalline and macrocrystalline talcs and tetradecyltrimethylammonium bromide (TTAB), using standard tap water. The foams were prepared and tested in the same way as in the previous examples. The results are shown in Table XII. The median particle sizes d₅₀, as measured by Sedigraph (ISO 13317-3), are indicated. The foam stability is indicated by the time required to drain 30% of the water from the foam.

TABLE XII

| Ex. | d₅₀ (μm) | time (min) |
|---|---|---|
| 26 | 3.6 | 16 |
| 27 | 3.6 | 7 |
| 28 | 1.8 | 20 |
| 29 | 2.2 | 17 |
| 30 | 2.1 | 21 |
| 31 | 2.2 | 18 |
| 32 | 1.4 | 38 |
| 33 | 1.9 | 25 |
| 34 | 2.2 | 21 |
| 35 | 1.5 | 33 |
| 36 | 1.9 | 24 |
| 37 | 2.3 | 20 |
| 38 | 1.9 | 42 |
| 39 | 4 | 11 |
| 40 | 1.2 | 44 |
| 41 | 2.2 | 39 |
| 42 | 5.0 | 7 |
| 43 | 5.2 | 10 |
| 44 | 3.3 | 12 |
| 45 | 3.7 | 9 |
| 46 | 7.5 | 5 |
| 47 | 2.4 | 10 |
| 48 | 5.6 | 10 |
| 49 | 11 | 8 |
| 50 | 9.5 | 8 |
| 51 | 7.9 | 11 |
| 52 | 4.2 | 13 |
| 53 | 2.3 | 15 |
| 54 | 2.7 | 6 |
| 55 | 2.2 | 16 |

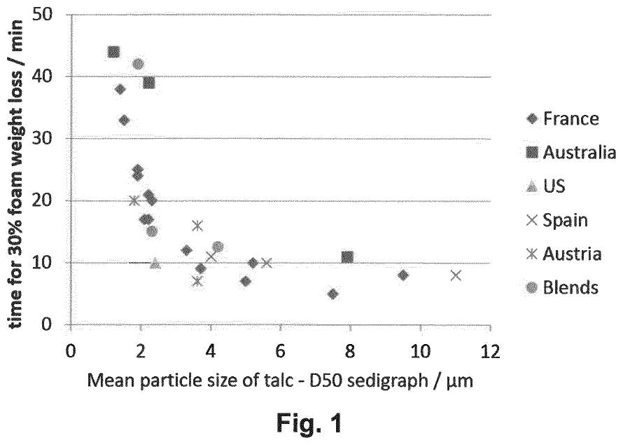

The results are graphically represented in FIG. 1, which also represents the geographical origin of the various talcs. While the graph indicates that there is some influence on foam stability from the talc's origin, the biggest effect is particle size; the finer the talc, the more stable is the foam.

### Example 56

Foams were tested in the presence of 1.0 wt.-% or 0.5 wt.-% of different minerals and sodium lauryl sulphate (SLS). The talc used was a high aspect ratio (HAR) talc provided by Imerys Talc having a BET surface area of 19 m²/g (ISO 9277) and a median particle size of 2.1 μm (by Sedigraph—ISO 13317-3). The calcium carbonate used was a precipitated calcium carbonate (PCC) provided by Imerys having a BET surface area of 19 m²/g (ISO 9277) and a median particle size of 2.1 μm (by Sedigraph—ISO 13317-3). The bentonite used was a bentonite provided by Imerys having a BET surface area of 54.4 m²/g (ISO 9277) and a median particle size of 16.8 μm (by wet Malvern laser scattering—ISO 13329-1). The mica used was a mica provided by Imerys having 64% particles having a particle size below 2 μm (measured by Sedigraph—ISO 13317-3). The SLS was used as a 3% aqueous stock solution. The foams were prepared by combining the mineral and SLS stock solution and making up to 100 g using water. The resulting compositions were mixed using a laboratory foam generator. The resulting foams were filled into a funnel cell with a frit and collector at the bottom, and left to stand. Any foam decomposition was measured by measuring the amount of water collected underneath the funnel cell. The varying test parameters are shown in Table XIII.

TABLE XIII

| Example | Composition |
|---|---|
| Comp. Ex. 56a | Water, 3 wt.-% SLS |
| Ex. 56b | Water, 3 wt.-% SLS, 1.0 wt-% talc |
| Ex. 56c | Water, 3 wt.-% SLS, 1.0 wt.-% PCC |
| Ex. 56d | Water, 3 wt.-% SLS, 1.0 wt.-% bentonite |
| Ex. 56e | Water, 3 wt.-% SLS, 1.0 wt.-% mica |
| Ex. 56f | Water, 3 wt.-% SLS, 1.0 wt.-% kaolin |
| Ex. 56g | Water, 3 wt.-% SLS, 0.5 wt.-% talc |
| Ex. 56h | Water, 3 wt.-% SLS, 0.5 wt.-% PCC |
| Ex. 56i | Water, 3 wt.-% SLS, 0.5 wt.-% bentonite |
| Ex. 56j | Water, 3 wt.-% SLS, 0.5 wt.-% mica |
| Ex. 56k | Water, 3 wt.-% SLS, 0.5 wt.-% kaolin |

The amount of water collected was observed for 30 minutes. The results are shown in Table XIV. The values shown are percentage values of foam remaining within the funnel cell, and can be seen as a measure of foam stability over time. The values shown in the column “FER” indicate the obtained foam expansion ratios.

TABLE XIV

Time (min)

| | 0 | 5 | 10 | 15 | 30 | FER |
|---|---|---|---|---|---|---|
| Comp. | 100 | 92.8 | 71.7 | 59.9 | 39.5 | 28.7 |
| Ex. 56a | | | | | | |
| Ex. 56b | 100 | 91.3 | 72.1 | 60.7 | 44.7 | 23.6 |
| Ex. 56c | 100 | 94.0 | 77.6 | 64.6 | 45.2 | 25.4 |
| Ex. 56d | 100 | 95.6 | 72.8 | 61.1 | 46.0 | 23.6 |
| Ex. 56e | 100 | 80.5 | 60.5 | 49.7 | 34.2 | 24.4 |
| Ex. 56f | 100 | 88.6 | 65.8 | 53.3 | 35.1 | 25.4 |
| Ex. 56g | 100 | 69.3 | 48.6 | 40.2 | 25.0 | 25.4 |
| Ex. 56h | 100 | 84.1 | 61.3 | 50.5 | 27.0 | 25.4 |
| Ex. 56i | 100 | 85.7 | 64.3 | 54.2 | 41.3 | 23.6 |
| Ex. 56j | 100 | 82.1 | 65.5 | 54.4 | 36.8 | 26.4 |
| Ex. 56k | 100 | 87.0 | 67.2 | 56.5 | 37.9 | 24.4 |

It was found that the Examples 56b to 56d and Example 56i lead to improved foam stability over comparative Example 56a (see Table XIV above). Examples 56e to 56h and Examples 56j and 56k have an equivalent or deteriorated foam stability but which remains acceptable. But it was also unexpected that all the above minerals have surprisingly shown to reduce or eliminate the transmission of the inflammable vapors through the foam compared to Comparative Example 56a.

1. An aqueous composition for suppressing fires, the composition comprising
a surfactant and/or a hydrotrope;
a particulate inorganic material, selected from the group consisting of perlite, talc, calcium carbonate, kaolin, dolomite, mica, and bentonite, and combinations thereof, and
optionally one or more additives.

2. An aqueous composition according to claim 1, wherein the said surfactant is selected from the group of cationic surfactants, non-ionic surfactants and anionic surfactants.

3. An aqueous composition according to claim 2, wherein the surfactant is a cationic surfactant, such as for example an alkyl trimethyl ammonium halide such as tetradecyl trimethyl ammonium bromide or dicocodimethylammonium chloride, or dihydrogenated tallowoylethyl hydroxyethylammonium methosulfate, or a polymeric quaternary ammonium ester.

4. An aqueous composition according to claim 2, wherein the surfactant is an anionic surfactant selected from alkyl ether sulphates, such as sodium lauryl ether sulphate, and alkyl sulphates, such as sodium lauryl sulphate.

5. An aqueous composition according to claim 1, wherein the inorganic particulate material is selected from the group consisting of talc, calcium carbonate, mica, and kaolin.

6. An aqueous composition according to claim 5, wherein the inorganic particulate material is microcrystalline talc, macrocrystalline talc, or a mixture thereof.

7. An aqueous composition according to claim 5, wherein the inorganic particulate material is synthetic talc.

8. An aqueous composition according to claim 5, wherein the said talc is a microcrystalline talc having a d₅₀ of 10 μm or lower.

9. An aqueous composition according to claim 1, wherein the ratio of surfactant to water is in the range of 0.01 to 5 wt.-%.

10. An aqueous composition according to claim 1, wherein the content of particulate inorganic powder in the composition is from 0.1 to 60 wt.-%, based on the total weight of the composition.

11. An aqueous composition according to claim 1, wherein the weight ratio of particulate inorganic powder to surfactant is in the range of from 500:1 to 1:1.

12. A dry precursor of the aqueous composition of claim 1, comprising a surfactant and/or a hydrotrope, and a particulate inorganic material, selected from the group consisting of perlite, talc, calcium carbonate, dolomite, mica, and bentonite, and combinations thereof, and optionally one or more additives.

13. A dry precursor according to claim 12, wherein the weight ratio of particulate inorganic powder to surfactant is in the range of from 500:1 to 1:1.

14. A fire extinguishing foam comprising an aqueous composition according to claim 1.

15. A method of making a fire extinguishing foam according to claim 14, comprising the steps of
providing a mixture of water and surfactant and/or a hydrotrope;
providing a particulate inorganic material, selected from the group consisting of perlite, talc, calcium carbonate, dolomite, mica, and bentonite, and combinations thereof;
optionally providing one or more additives;
mixing the said mixture of water and surfactant and/or a hydrotrope, the said particulate inorganic material and optionally the said one or more additives; and
foaming the obtained mixture.

16. A method of making a fire extinguishing foam according to claim 14, comprising the steps of
providing a dry precursor according to claim 12;
providing water;
optionally providing one or more additives;
mixing the said dry precursor, the said water and optionally the said one or more additives;
foaming the obtained mixture.

17. (canceled)

18. (canceled)

19. A method of extinguishing a fire, comprising applying a particulate inorganic mineral as defined in claim 1.

20. An aqueous composition according to claim 2, wherein the inorganic particulate material is selected from the group consisting of talc, calcium carbonate, mica, and kaolin.

21. An aqueous Aqueous composition according to claim 2, wherein the ratio of surfactant to water is in the range of 0.01 to 5 wt. %.

22. An aqueous composition according to claim 21, wherein the content of particulate inorganic powder in the composition is from 0.1 to 60 wt. %, based on the total weight of the composition.
